(19) United States
(12) Patent Application Publication
(10) Pub. No.: US 2025/0246196 A1
(43) Pub. Date: Jul. 31, 2025

(54) METHOD AND APPARATUS FOR SPEECH SEPARATION

(71) Applicants: HYUNDAI MOTOR COMPANY, Seoul (KR); KIA CORPORATION, Seoul (KR); SOGANG UNIVERSITY RESEARCH & BUSINESS DEVELOPMENT FOUNDATION, Seoul (KR)

(72) Inventors: Ran Lee, Hwaseong-si (KR); Hee Baek Yun, Hwaseong-si (KR); Young Ju Cheon, Hwaseong-si (KR); Ui-Hyeop Shin, Seoul (KR); Hyung Min Park, Seoul (KR)

(73) Assignees: HYUNDAI MOTOR COMPANY, Seoul (KR); KIA CORPORATION, Seoul (KR); SOGANG UNIVERSITY RESEARCH & BUSINESS DEVELOPMENT FOUNDATION, Seoul (KR)

(21) Appl. No.: 19/029,858

(22) Filed: Jan. 17, 2025

(30) Foreign Application Priority Data
Jan. 30, 2024 (KR) 10-2024-0014246
Aug. 1, 2024 (KR) 10-2024-0102592

(51) Int. Cl. G10L 19/008; G10L 25/30

(52) U.S. Cl. CPC G10L 19/008; G10L 25/30

(57) ABSTRACT

A method and an apparatus for separating speeches based on local and global modeling network (LAGNet) are provided. A speech separation apparatus includes an encoder configured to progressively compress a sequence of mixed speeches by using a one-dimensional convolution-based local block to generate local information, a bottleneck configured to generate global information by using a multiple self attention-based global block, and a decoder configured to progressively reconstruct the sequence by using the local block. A speech separation apparatus also utilizes a skip connection that includes gates configured to filter the local information by using the global information.

### CROSS-REFERENCE TO RELATED APPLICATIONS

This application claims priority to and the benefit of Korean Patent Application No. 10-2024-0014246, filed on Jan. 30, 2024, and Korean Patent Application No. 10-2024-0102592, filed on Aug. 1, 2024, the entire contents of each of which are hereby incorporated herein by reference.

### TECHNICAL FIELD

The present disclosure relates to a method and an apparatus for separating speeches based on local and global modeling network (LAGNet).

### BACKGROUND

The statements in this section merely provide background information related to the present disclosure and do not necessarily constitute prior art.

Speech separation extracts each speaker's individual speech from mixed speeches produced by two or more speakers speaking simultaneously. The speech separation model does not use a separate short-time Fourier transform (STFT) to process mixed speeches but utilizes an end-to-end processing method to handle mixed speeches directly in the time domain. To learn a representation that replaces the STFT domain, the speech separation model utilizes a one-dimensional convolution-based audio encoder and decoder that replaces STFT and inverse STFT (iSTFT) operations. The conv-TasNet (Time-domain Audio Separation Network) model is employed as a speech separation model that processes mixed speeches in the time domain based on one-dimensional convolution. By accumulating a one-dimensional convolution-based Temporal Convolutional Network (TCN) based on dilation of powers of 2, the conv-TasNet implements local modeling and secures a sufficient receptive field. Compared to STFT-based models, the conv-TasNet (Time-domain Audio Separation Network) model shows excellent performance in terms of scale-invariant signal-to-noise ratio improvement (SI-SNRi).

However, TasNet has a problem in that it lacks global modeling in spite of the need to process a very long sequence in the time domain. To effectively process a long sequence, Bidirectional Long Short Term Memory (Bi-LSTM)-based Dual-path Recurrent Neural Network (DPRNN) or Transformer-based Sepformer is proposed as a speech separation model based on a dual-path sequence model. The speech separation model based on the dual path model splits a very long sequence into chunks with a predetermined length and utilizes a path to process intra-chunk sequences and a path to process inter-chunk external sequences. Intra-chunk sequences and inter-chunk external sequences correspond to local modeling and global modeling for long sequences, respectively. While the speech separation model based on the dual-path model significantly improves the performance of TasNet, it still has a problem of requiring substantial computational resources for creating chunks and processing inter-chunk sequences.

To mitigate the excessive amount of computation inherent to the dual-path model, the Successive Downsampling and Resampling of Multi-Resolution Features (SuDoRM-RF) model is proposed as a speech separation model that leverages a multi-scale sequence model. The SuDoRM-RF model utilizes a multi-scale sequence model based on U-net to expand the receptive field, thereby reducing the amount of computation. However, since all layers in the multi-scale sequence model are implemented as one-dimensional convolutions, the SuDoRM-RF model still has a problem in that it does not effectively model the global information of the sequence.

### SUMMARY

Therefore, a speech separation model capable of reducing the amount of computation while improving the performance of speech separation by processing global information in addition to local information of the sequence should be considered.

Embodiments of the present disclosure provide a method and an apparatus for separating speeches using the local and global modeling Network (LAGNet), which is a deep learning-based speech separation model that includes a multi-scale sequence model.

In addition, embodiments of the present disclosure provide a method and an apparatus for separating speeches using a multi-scale sequence model. The multi-scale sequence model includes an encoder that progressively compresses a sequence of mixed speeches by using a one-dimensional convolution-based local modeling block, a bottleneck that utilizes a multiple self attention-based global modeling block, and a decoder that progressively reconstructs the sequence by using the local modeling block.

According to at least one aspect of the present disclosure, a speech separation apparatus is provided. The speech separation apparatus includes a local encoder including local encoder stages, allowing each local encoder stage to generate local information by progressively compressing latent representations of mixed speeches by using the local encoder stages, and generating compressed output based on output of last local encoder stage. The speech separation apparatus also includes a bottleneck including a global stage and generating global information from the compressed output of the local encoder by using the global stage.

The speech separation apparatus also includes a local decoder including local decoder stages, allowing each local decoder stage to generate reconstructed local information by progressively expanding the global information by using the local decoder stages, and providing output of last local decoder stage as reconstructed latent output. The speech separation apparatus also includes a skip connection including global gates and local gates, filtering local information of the local encoder stages by using the global gates and the global information, and filtering output of the global gates by using the local gates and the reconstructed local information of the local decoder stages.

According to another aspect of the present disclosure, a method for separating speeches performed by a speech separation apparatus is provided. The method includes allowing each local encoder stage to generate local information by progressively compressing latent representations of mixed speeches by using local encoder stages within a local encoder. The method also includes generating compressed output based on output of last local encoder stage. The method also includes generating global information from the compressed output of the local encoder by using a global stage. The method also includes allowing each local decoder stage to generate reconstructed local information by progressively expanding the global information by using local decoder stages within a local decoder. The method also includes providing output of last local decoder stage as reconstructed latent output. The method also includes filtering local information of the local encoder stages by using global gates and the global information. The method also includes filtering output of the global gates by using local gates and reconstructed local information of the local decoder stages.

According to yet another aspect of the present disclosure, a non-transitory computer-readable recording medium storing instructions is provided. The instructions, when executed by a computer, enables the computer to perform operations. The operations include allowing each local encoder stage to generate local information by progressively compressing latent representations of mixed speeches by using local encoder stages within a local encoder. The operations also include generating compressed output based on output of last local encoder stage. The operations additionally include generating global information from the compressed output of the local encoder by using a global stage. The operations further include allowing each local decoder stage to generate reconstructed local information by progressively expanding the global information by using local decoder stages within a local decoder. The operations further still include providing output of last local decoder stage as reconstructed latent output. The operations also include filtering local information of the local encoder stages by using global gates and the global information. The operations additionally include filtering output of the global gates by using local gates and reconstructed local information of the local decoder stages.

As described above, the present disclosure provides a method and an apparatus for separating speeches using LAGNet, a deep learning-based speech separation model that includes a multi-scale sequence model. Thus, the method and the apparatus for separating speeches improve the performance of speech separation while reducing the amount of computation of the speech separation model.

In addition, as described above, the present disclosure provides a method and an apparatus for separating speeches using a multi-scale sequence model. The multi-scale sequence model includes an encoder that progressively compresses a sequence of mixed speeches using a one-dimensional convolution-based local modeling block, a bottleneck that utilizes a multiple self attention-based global modeling block, and a decoder that progressively restores the sequence using the local modeling block. Thus, the method and the apparatus for separating speeches effectively process local and global information of the sequence.

### BRIEF DESCRIPTION OF THE DRAWINGS

FIG. 1 conceptually illustrates a speech separation apparatus according to one embodiment of the present disclosure.

FIG. 2 illustrates a multi-scale local-global sequence model according to one embodiment of the present disclosure.

FIG. 3 illustrates a dual-path sequence model.

FIG. 4 illustrates a multi-scale sequence model.

FIG. 5 illustrates a speech separation model that utilizes a multi-scale local-global sequence modeling according to one embodiment of the present disclosure.

FIG. 6 illustrates a global block according to one embodiment of the present disclosure.

FIG. 7 illustrates a local block according to one embodiment of the present disclosure.

FIG. 8 illustrates a global gate according to one embodiment of the present disclosure.

FIG. 9 illustrates a local gate according to one embodiment of the present disclosure.

FIG. 10 is a flow diagram illustrating a method for separating speeches by a speech separation apparatus according to one embodiment of the present disclosure.

FIG. 11 is a block diagram illustrating an example of a computing device according to one embodiment of the present disclosure.

### DETAILED DESCRIPTION

Hereinafter, some embodiments of the present disclosure are described in detail with reference to the accompanying illustrative drawings. In the accompanying drawings, like reference numerals designate like elements even when the elements are shown in different drawings. Further, in the following description, detailed descriptions of related known components and functions, where considered to obscure the subject matter of the present disclosure, have been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when it is said that a part'includes', ‘has’, ‘comprises’, and the like, a component, the part is meant to further include one or more other components, not to exclude other components, unless specifically stated to the contrary. The terms such as ‘unit’, ‘module’, and the like refer to one or more units for processing at least one function or operation, which may be implemented by hardware, software, or a combination thereof.

When a component, device, unit, element, or the like of the present disclosure is described as having a purpose or performing an operation, function, or the like, the component, device, or element should be considered herein as being “configured to” meet that purpose or perform that operation or function.

The detailed description set forth below in conjunction with the accompanying drawings is intended to illustrate embodiments of the present disclosure. The detailed description is not intended to represent the only embodiments in which the present disclosure may be practiced.

The present disclosure in some embodiments relates to speech separation for separating speeches of individual speakers from mixed speeches. More specifically, the present disclosure provides a speaker verification method and apparatus for separating speeches using the Local and Global modeling Network (LAGNet), which is a deep learning-based speech separation model that includes a multi-scale sequence model.

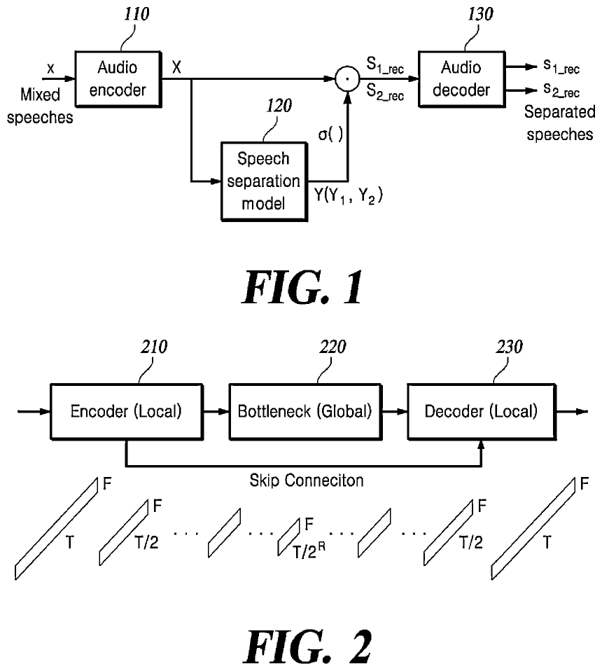

FIG. 1 conceptually illustrates a speech separation apparatus according to one embodiment of the present disclosure.

The speech separation apparatus according to embodiments of the present disclosure encodes mixed speeches to generate (mixed) latent representations, processes the latent representations locally and globally to generate separation output and individual masks, separates masked latent representations by applying individual masks to the latent representations, and reconstructs the individual speeches based on the masked latent representations. Here, mixed speeches refer to speeches generated by simultaneous utterances of two or more speakers. The speech separation apparatus comprises all or part of an audio encoder 110, a speech separation model 120, and an audio decoder 130. Here, constituting elements included in the speech separation apparatus according to embodiments of the present disclosure are not necessarily limited to the specific example above. The speech separation apparatus additionally may include a trainer (not shown) for training the audio encoder 110, the speech separation model 120, and the audio decoder 130 or may be implemented in a form linked to an external trainer.

In one embodiment, in the example of FIG. 1, two speakers are assumed. The speeches resulting from utterances of the two speakers are represented by s₁ and s₂, and the mixed speech x represents the mixing of s₁ and s₂. In general, mixed speech may include utterances by J speakers (where J is a natural number of 2 or greater).

In the following description, the speech separation model 120 and the separator are used interchangeably.

The audio encoder 110 replaces STFT and performs one-dimensional convolution in the time domain to generate latent representation X from the mixed speech.

The speech separation model 120 processes the latent representation X locally and globally to generate the separator output Y (Y₁, Y₂). The speech separation apparatus generates masks M₁, M₂ by applying an activation function, for example, a sigmoid function, to the separator output. The speech separation apparatus separates the masked latent representations S_{1_rec}, S_{2_rec} by applying element-wise product \textcircled{·} between the latent representation X and the masks.

The audio decoder 130 replaces iSTFT based on the masked latent representations s_{1_rec}, s_{2_rec} and performs one-dimensional convolution in the time domain to finally reconstruct the individual speeches s_{1_rec}, s_{2_rec}.

When the audio encoder 110, the speech separation model 120, and the audio decoder 130 are trained end-to-end, the speech according to each speaker's utterance may be used as the ground truth (GT).

Since the audio encoder 110 and the audio decoder 130 perform transformation and inverse transformation between latent representations and speeches in the time domain, the speech separation model 120 is generally described below in relation to speech separation.

To effectively separate speeches from mixed speech in the time domain, the speech separation model 120 has to effectively utilize and preserve detailed information obtained from the input speech in a way similar to speech enhancement. To process the detailed information, the speech separation model 120 has to effectively process the local information. Also, unlike the speech enhancement, the speech separation model 120 has to effectively process the global information inherent to each speaker to resolve permutation on the time axis for each speech source. The speech separation model 120 according to embodiments of the present disclosure effectively separates speeches in the time domain by processing a sequence elongated by simultaneously combining local modeling and global modeling. Also, the speech separation model 120 according to embodiments of the present disclosure may require a small amount of computation in processing both local and global information.

In the following description, the terms ‘sequence’ and ‘representation’ may be used interchangeably. In other words, the representation may include temporal information.

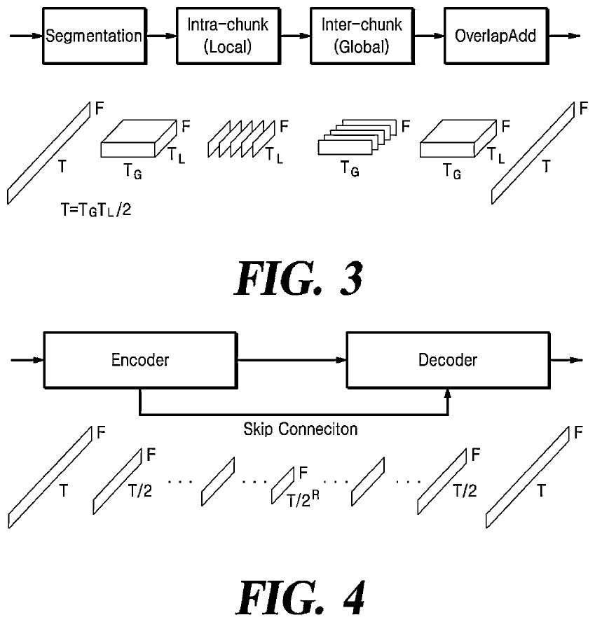

The speech separation model 120 according to embodiments of the present disclosure utilizes a multi-scale local-global sequence modeling technique, as shown in FIG. 2. By utilizing a multi-scale local-global sequence modeling technique, the speech separation model 120 according to embodiments of the present disclosure is allowed to maintain a significantly reduced amount of computation compared to the models like DPRNN or Sepformer that employs the dual-path sequence model shown in FIG. 3. Also, compared to the model such as SuDoRM-RF, which utilizes a multi-scale sequence model as illustrated in FIG. 4, the speech separation model 120 according to embodiments of the present disclosure may effectively utilize global information.

As illustrated in FIG. 2, in an embodiment, the speech separation model 120 comprises a local encoder 210 that progressively compresses a sequence by employing a one-dimensional convolution-based local modeling block, a bottleneck (e.g., a bottleneck module) 220 employing a multiple self-attention-based global modeling block, a local decoder 230 that progressively reconstructs the sequence using the local modeling block, and a skip connection. In the example of FIG. 2, F represents the number of reduced features generated from latent representation X. F features constitute one frame. T represents the number of frames (i.e., F-dimensional vector) and represents the temporal length of the sequence of frames. The local encoder 210 and local decoder 230 each include R stages, and the bottleneck 220 includes a central stage. A detailed structure and operation of the local encoder 210, bottleneck 220, and local decoder 230, according to embodiments, are described later.

In the following description, local modeling blocks are used interchangeably with local blocks. Also, global modeling blocks are used interchangeably with global blocks. Further, in the following description, the terms ‘sequence’ and ‘frame sequence’ may

be used interchangeably.

As illustrated in FIG. 3, a separator utilizing a dual-path sequence model includes segmentation, intra-chunk, inter-chunk, and overlap-add steps to model a long sequence. The segmentation step splits a long sequence into chunks with a fixed length, allowing for overlapping between the chunks. In the example of FIG. 3, T_{L} represents the size of the chunk obtained by splitting of frames, and T_{G} represents the number of chunks. If an overlap of 50% is allowed, the number of frames may be defined as T=T_{G}T_{L}/2. The intra-chunk step corresponds to local modeling for the long sequence, and the inter-chunk step corresponds to global modeling for the long sequence. The overlap-add step produces separator output based on the sequence processed by the intra-chunk and inter-chunk steps.

As illustrated in FIG. 4, a separator utilizing a multi-scale sequence model includes an encoder, decoder, and skip connection based on U-net to reduce the amount of computation. Compared to the speech separation model 120 according to embodiments of the present disclosure, the separator utilizing the multi-scale sequence model does not include the bottleneck 220 and therefore does not effectively model the global information of the sequence.

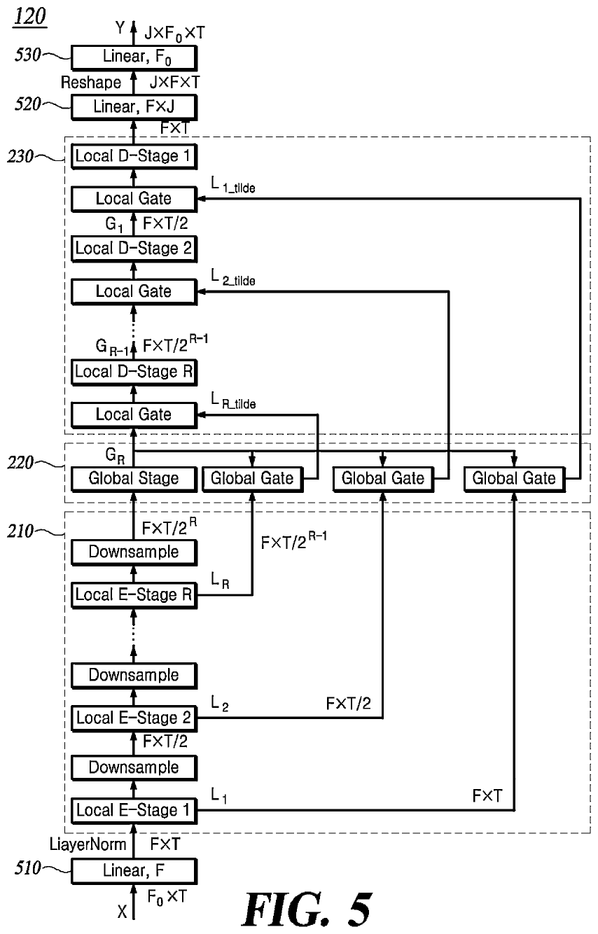

FIG. 5 illustrates a speech separation model that utilizes a multi-scale local-global sequence modeling according to one embodiment of the present disclosure.

As described above, the speech separation model 120 according to embodiments of the present disclosure includes a local encoder 210, a bottleneck 220, and a local decoder 230. The speech separation model 120 additionally includes three linear layers 510, 520, 530. As shown in FIG. 5, the speech separation model 120 additionally utilizes the skip connection that includes global and local gates.

The LAGNet according to embodiments of the present disclosure represents a speech separation apparatus as shown in FIG. 1. Alternatively, the LAGNet may specifically represent the speech separation model 120 as shown in FIG. 5.

The latent representation X is generated by the audio encoder 110 and has dimensions of F₀×T. F₀ represents the number of features in the latent representation, and T represents the number of frames. In the latent representation X, one frame contains F₀ features. In general, the latent representation X may be generated from the mixed speech based on the utterances of J speakers.

The linear layer 510 generates a reduced feature F from the input latent representation. F features constitute one frame. To normalize the output of the linear layer 510, a Layer Normalization (LayerNorm) layer follows the linear layer 510. The output of the linear layer 510 has dimensions of F×T. The output of the linear layer 510 is provided to the local encoder 210. The LayerNorm normalizes samples by using the mean and variance of the layer's output samples.

The local encoder 210 is a temporal contracting encoder, consisting of R (where R is a natural number of 1 or more) local encoder stages (local E-stages). Each local encoder stage consists of repeated local blocks. A downsampling layer follows each local encoder stage. The local encoder 210 progressively compresses the sequence by using downsampling. Before downsampling is applied, each local encoder stage captures local context to generate local information.

As shown in the example of FIG. 5, the output of the r-th (r=1, 2, . . . , R) local encoder stage is represented by Lᵣ and has dimensions of F×T/2^{r-1}. The dimension of the output of the r-th local encoder stage is changed to F×T/2^{r} by the r-th downsampling layer. The output of the r-th (r=1, 2, . . . , R−1) downsampling layer is provided to the (r+1)-th local encoder stage. The output of the last R-th downsampling layer and the output of the r-th (r=1, 2, . . . , R) local encoder stage are provided to the bottleneck 220.

The bottleneck 220 includes a global stage, which consists of B repeated global blocks (where B is a natural number greater than or equal to 1). The bottleneck 220 processes the global information based on one sequence compressed by the local encoder 210. The output of the global stage is denoted by G_{R} and has dimensions of F×T/2^{r}. The output of the global stage is provided to the local decoder 230.

The local decoder 230 is a temporal expanding decoder and consists of R local decoder stages (local D-stages) corresponding to the local encoder stages. Each local decoder stage consists of repeated local blocks. At the front of each local decoder stage, a local gate including an upsampling layer is positioned. The local decoder 230 progressively reconstructs the sequence based on repeated local gates and local decoder stages.

As shown in the example of FIG. 5, the input of the r-th (r=R, R−1, . . . , 1) local gate is represented by Gᵣ and has dimensions of F×T/2^{r}. The output of the r-th local gate is changed to F×T/2^{r-1} dimensions by the upsampling layer. The output of the r-th local gate is provided to the r-th local decoder stage. The output of the last local decoder stage, i.e. the reconstructed output of local decoder 230, is provided to linear layer 520. The reconstructed output of the local decoder 230 has the same F×T dimensions as the input of the local encoder 210.

For progressive expansion/restoration of sequences, skip connection may be utilized. Skip connection connects corresponding encoder stages and decoder stages by using global and local gates. The global gate filters local information, and the local gate filters the output of the global gate. Like the local gate, the global gate includes the upsampling layer and assists in gradually expanding the sequence. Similar to the local gate, R global gates are employed. The global gate is included in the bottleneck 220, while the local gate is included in the local decoder 230, as described above.

As show in the example of FIG. 5, the output of the r-th (r=1, 2, . . . , R) local encoder stage and the output of the global stage are provided to the r-th global gate. The output of the r-th global gate is denoted by L_{r_tilde}. The output of the r-th global gate is provided to the corresponding r-th local gate within the local decoder 230.

As shown in the example of FIG. 5, the local decoder stage corresponding to the local encoder stage is positioned symmetrically around the bottleneck. One global gate and one local gate (i.e., the corresponding local gate) may form a skip connection for the local encoder stage and local decoder stage corresponding to each other. Alternatively, one local gate and one global gate (i.e., the corresponding global gate) may form a skip connection.

The linear layer 520 and the reshape layer reshape the reconstructed output of the local decoder 230 to create a separate representation for each speaker. The output of the reshape layer has dimensions of J×F×T, where, as described above, J represents the number of speakers included in the mixed speech. The output of the reshape layer is provided to the linear layer 530.

The linear layer 530 expands the features of separate representations generated by the preceding linear layer 520 and finally produces a separator output Y. The separator output Y has dimensions of J×F₀×T. The output of the linear layer 530 is provided to the audio decoder 130.

The linear layers 510, 520, 530 may be fully-connected layers, respectively.

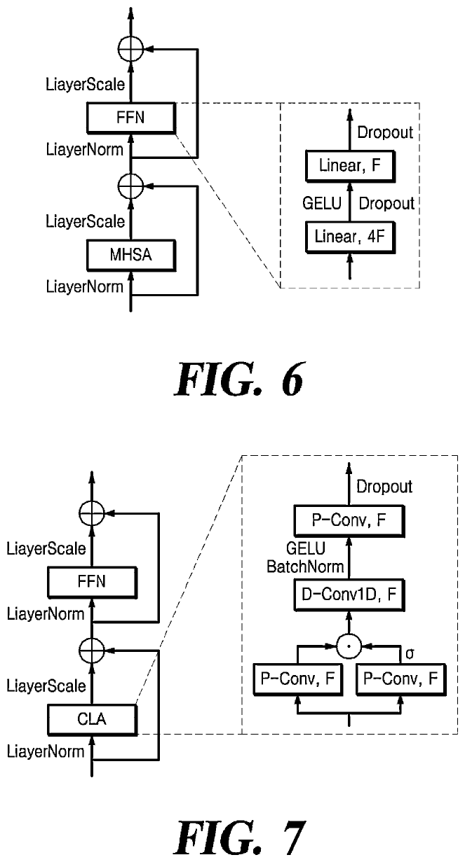

FIG. 6 illustrates a global block according to one embodiment of the present disclosure.

As described above, the global stage within the bottleneck 220 includes a plurality of global blocks. Global blocks generate global information GR from one sequence compressed by the local encoder 210. One global block includes the Transformer's Multi-head Self Attention (MHSA) module and the feed-forward network (FFN). As illustrated in FIG. 6, FFN includes linear layers supporting hidden features of 4F dimension and additionally includes a Gaussian Error Linear Unit (GELU) activation function and a dropout layer. Each of the MHSA module and the FFN utilizes a residual connection. By positioning the Layerscale layer and the LayerNorm layer before and after the MHSA module and the FFN, the training speed and performance of the global stage may be improved. Element-wise multiplication is applied between the Layerscale layer and the MHSA module and between the Layerscale layer and the FFN. The dropout layer plays the role of dropping part of the network to prevent overfitting.

FIG. 7 illustrates a local block according to one embodiment of the present disclosure.

As described above, the local encoder stage in the local encoder 210 and the local decoder stage in the local decoder 210 include a plurality of local blocks. Local blocks in the r-th local encoder stage generate local information Lᵣ, and local blocks in the r-th local decoder stage generate local information Gᵣ₋₁. One local block includes a convolutional local attention (CLA) module and the FFN. In other words, the local block uses the CLA module, replacing the MHSA module of the global block.

The CLA module attentively captures local context based on a Gated Linear Unit (GLU) that dynamically gates input features. As illustrated in FIG. 7, the GLU includes two parallel Pointwise Convolution (P-Conv) blocks. The GLU applies an activation function (e.g., sigmoid function) to one P-Conv output and multiplies the output of the activation function with the output of the remaining P-Conv blocks element-wise.

The CLA module includes a GLU, a 1-Dimensional Depthwise Convolution (D-Conv1D) block, and a P-Conv block. The kernel size of the D-Conv1D block is K. In other words, the D-Conv1D block processes information corresponding to K frames. A Batch Normalization (BatchNorm) layer and a GELU follow the D-Conv1D block. The CLA module additionally includes a P-Conv block and a dropout layer at the rear of the GELU. The BatchNorm layer normalizes the samples by using the mean and variance of the batch output samples.

Each of the CLA module and the FFN utilizes a residual connection. By positioning the Layerscale layer and the LayerNorm layer before and after the CLA module and the FFN, the training speed and performance of the local encoder/decoder stages may be improved. Element-wise multiplication is applied between the Layerscale layer and the CLA module and between the Layerscale layer and the FFN.

The first local encoder stage and the first local decoder stage include C₁ local blocks. The remaining local encoder stages and local decoder stages include C₂ (<C₁) local blocks.

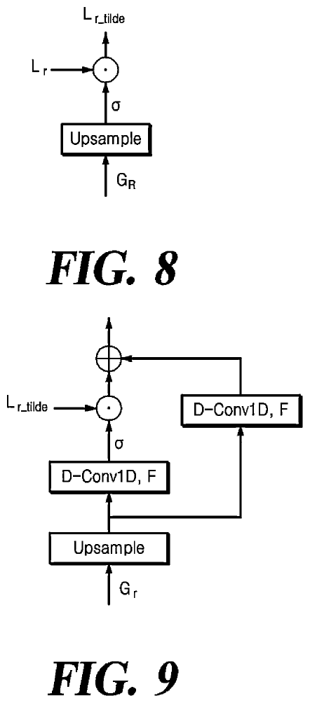

FIG. 8 illustrates a global gate according to one embodiment of the present disclosure.

As described above, the global gate exists on a skip connection and is included in the bottleneck 220. The global gate filters the output of the r-th local encoder stage on the skip connection by using G_{R}, which is the output sequence of the global stage, and then provides the filtered sequence to the corresponding local gate.

In the example of FIG. 8, the operation of the r-th global gate is described. To match the dimensionality with the output of the corresponding local encoder stage, the r-th global gate upsamples G_{R}, the output sequence of the global stage, by using the upsampling layer. For example, the upsampling layer may upsample the input sequence by using the nearest neighbor interpolation. The output of the upsampling layer has dimensions of F×T/2^{r-1}. The r-th global gate generates gate values by applying an activation function, for example, a sigmoid function, to the output of the upsampling layer. The r-th global gate generates the output of the r-th global gate by applying element-wise product \textcircled{·} between the output of the corresponding local encoder stage and gate values.

FIG. 9 illustrates a local gate according to one embodiment of the present disclosure.

As described above, the local gate is positioned at the front of the local decoder stage within the local decoder 230. The local gate connects the previous local decoder stage and the current local decoder stage and configures a skip connection with the corresponding local encoder stage. The local gate generates a filtered sequence by filtering the output of the global gate by using the output of the previous local decoder stage and finalizes the skip connection. The local gate generates output by adding the output of the previous local decoder stage and the filtered sequence and provides the generated output to the next local decoder stage. The first local gate uses the output of the global stage. By utilizing the local gate based on the output of the global gate, the local decoder 230 may efficiently reconstructs locally missing information.

In the example of FIG. 9, the operation of the r-th local gate is described. To match the dimensionality with the output of the corresponding global gate, the r-th local gate upsamples the input sequence G_{R}. For example, the upsampling layer may upsample the input sequence by using the nearest neighbor interpolation. The output of the upsampling layer has dimensions of F×T/2^{r-1}. The output of the upsampling layer at the r-th local gate is applied to two separated D-Conv1D blocks. The r-th local gate generates gate values by applying an activation function to the output of one D-Conv1D layer. The r-th local gate completes the skip connection by generating a filtered sequence through element-wise product \textcircled{·} between the output of the corresponding global gate and gate values. Finally, the r-th local gate generates the output of the r-th local gate by adding the output of the remaining D-Conv1D blocks and the filtered sequence on the skip connection.

In the following description, the operations of the Conv1D layer, P-Conv block, and D-Conv1D block, according to embodiments, are described. The Conv1D layer generates F₀×T dimensional output from input samples. The P-Conv block and D-Conv1D block are assumed to have outputs of F×T dimensions. As described above, F represents the number of features (i.e., channels), and T represents the length of a frame sequence. The direction in which the channel index increases is defined as the channel direction, and the direction in which the index of the frame within the sequence increases is defined as the time direction. Since the Conv1D layer, P-Conv block, and D-Conv1D block all perform 1D convolution, their kernels are all defined in the time direction.

The Conv1D layer generates features in the time direction by applying the kernel in the time direction and adding the generated results in the channel direction. The Conv1D layer uses F₀ kernels to generate F₀×T dimensional output. Since channel-wise operations are performed, the Conv1D layer may be used to adjust the number of channels between input and output. For example, in the audio encoder 110, the Conv1D layer adjusts the number of channels between input and output from 1 to F₀.

The P-Conv block generates features along the channel direction by applying a weighted sum to the output generated using a kernel of size 1 in the channel direction. The kernel of the P-Conv block has a size of 1 in the time direction and, for example, has weights corresponding to the number of input channels in the channel direction. The P-Conv block uses F kernels to generate F×T dimensional output. Since the P-Conv block performs operations in the channel direction without involving operations in the time direction, features that reflect the context within the sample may be generated. Since operations are performed in the channel direction, the P-Conv block may be used to adjust the number of channels between input and output. In the present disclosure, the P-Conv block is used to maintain, increase, or decrease the number of channels between input and output.

The D-Conv1D block generates features in the time direction by applying a large-sized kernel in the time direction. The D-Conv1D block uses F kernels to generate F×T dimensional output. Since the D-Conv1D block performs operations in the time direction without involving operations in the channel direction, features that reflect the context between frames may be generated. Since no operations are performed in the channel direction, the D-Conv1D block maintains the number of channels between input and output.

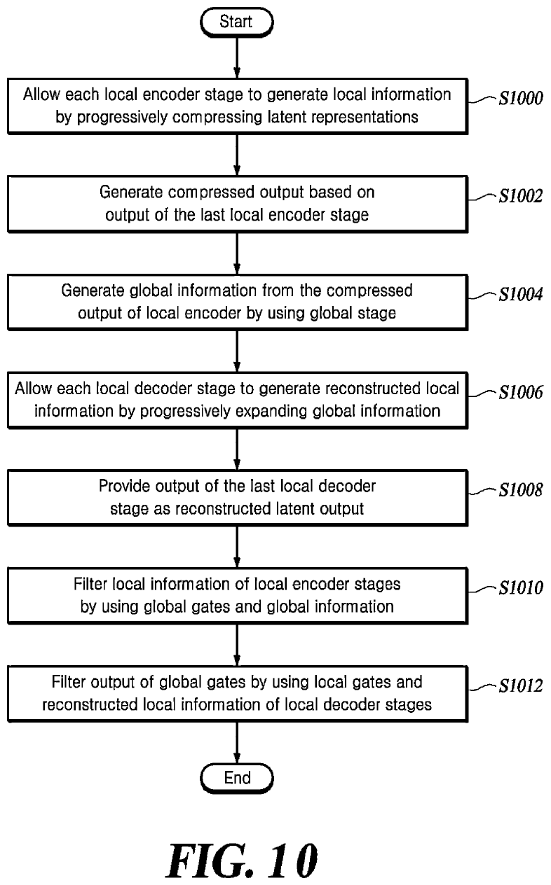

A method for separating speeches by a speech separation apparatus, according to an embodiment, is described below with reference to the example of FIG. 10.

FIG. 10 is a flow diagram illustrating a method for separating speeches by a speech separation apparatus according to one embodiment of the present disclosure.

The speech separation apparatus uses local encoder stages within the local encoder to progressively compress the latent representations of the mixed speech, allowing each local encoder stage to generate local information, in an operation S1000.

The speech separation apparatus generates latent representations from the mixed speech based on one-dimensional convolution. The speech separation apparatus may reduce the number of features of the latent representations by using the linear layer 510 and the LayerNorm layer. The mixed speech is created by mixing utterances from multiple speakers.

Each local encoder stage includes local blocks. Local blocks generate local information. Each local block includes a convolutional local attention (CLA) module and a feed-forward network (FFN). The CLA module includes a Gated Linear Unit (GLU) and a D-Conv1D block. The CLA module captures local context by dynamically gating input features based on the GLU.

The speech separation apparatus additionally includes downsampling layers. Each downsampling layer downsamples the output of each local encoder stage and provides the downsampled output to the next local encoder stage.

In an operation S1002, the speech separation apparatus generates a compressed output based on the output of the last local encoder stage. The last downsampling layer downsamples the output of the last local encoder stage to generate a compressed output and provides the compressed output to the global stage.

In an operation S1004, the speech separation apparatus generates global information from the compressed output of the local encoder by using a global stage.

The global stage includes global blocks. Global blocks generate global information. Each global block includes a multi-head self attention (MHSA) module and a feedforward network.

In an operation S1006, the speech separation apparatus uses local decoder stages within the local decoder to progressively expanding the global information, allowing each local decoder stage to generate reconstructed local information.

Each local decoder stage includes local blocks. Local blocks generate reconstructed local information. Each local block includes a CLA module and a feedforward network.

In an operation S1008, the speech separation apparatus provides the output of the last local decoder stage as the reconstructed latent output.

In an operation S1010, the speech separation apparatus filters local information of local encoder stages by using global gates and global information.

The speech separation apparatus upsamples global information by using an upsampling layer within each global gate. The speech separation apparatus filters the local information of each local encoder stage by using the upsampled global information, thereby generating a filtered output. The speech separation apparatus provides the output of each global gate to the corresponding local gate.

In an operation S1012, the speech separation apparatus filters the output of the global gates by using the reconstructed local information of the local gates and local decoder stages.

The speech separation apparatus uses the upsampling layer in each region gate to upsample the reconstructed local information of the previous local decoder stage of each local decoder stage. The speech separation apparatus generates a filtered sequence by filtering the output of the corresponding global gate using the upsampled reconstructed local information.

The speech separation apparatus generates output by adding the upsampled reconstructed local information and the filtered sequence and provides the generated output to each local decoder stage. Each global gate and the corresponding local gate connect each local encoder stage and the corresponding local decoder stage.

The speech separation apparatus reshapes the reconstructed latent output by using the linear layer 520 and the reshape layer, thereby generating separated representations for each speaker.

The speech separation apparatus may increase the number of features of the separated representations by using the linear layer 530.

The speech separation apparatus reconstructs the speech of each speaker from separated representations and latent representations for each speaker based on one-dimensional convolution.

In the following description, experimental results demonstrating the performance of LAGNet, which is the speech separation model, are described.

The performance of the speech separation model may be measured based on the Scale-Invariant Signal-to-Noise Ratio improvement (SI-SNRi), the Signal-to-distortion Ratio improvement (SDRi), the magnitude of model, a computational load of the model, and the computation speed of the model. The present disclosure presents simulation results that measure the performance of the above-described elements.

As described above, the speech separation apparatus according to the present disclosure may allow for a trade-off between the performance and the computation speed by flexibly adjusting the number of stages and blocks within the local encoder 210, bottleneck 220, and local decoder 230 included in the speech separation model 120. In other words, the speech separation apparatus according to the present disclosure may use a multi-scale sequence model, requiring a small computational amount while maintaining the same level of performance compared to the latest speech separation models such as DPRNN and Sepformer.

As described above, each of the local encoder 210 and the local decoder 230 may repeatedly include R local stages. C₁ or C₂ local blocks may be included in each local stage. The global stage of the bottleneck 220 may repeatedly include B global blocks.

In the simulation, a database for speech separation (e.g., WSJ0-2Mix or WHAM!) is used for training and verification. The mixed speeches included in the database WSJ0-2Mix are created by mixing utterances from different speakers at a relative signal-to-noise ratio (SNR) between −5 and 5 dB. The mixed speeches have a sampling rate of 8 kHz, and 4-second segments are used for training. WHAM! is a database created by adding noise to the mixed speeches of WSJ0-2Mix.

In the LAGNet according to embodiments of the present disclosure, the kernel size and stride of the audio encoder 110 and the audio decoder 130 are set to 4 ms and 1 ms, respectively, for one-dimensional convolution. In other words, with overlapping strides, each frame includes features corresponding to a length of 4 ms. The number F₀ of filters (i.e., features) used by the audio encoder 110 is set to 256. The number F of features reduced by the linear layer 510 is set to 96. Therefore, one frame includes F features corresponding to the length of 4 ms. The number R of local stages within the local encoder 210 and local stages within the local decoder 230 is set to 4. The number of MHSA heads in the global block is set to 8. In the CLA module of the local block, the kernel size K of the D-Conv1D block is set to 65. In other words, the D-Conv1D block in the CLA module processes information of 65 frames.

Table 1 shows the LAGNet with different configurations and the corresponding performance metrics.

TABLE 1

| | | (C₁, C₂) | | Parameters | MACs | SI-SNRi |
|---|---|---|---|---|---|---|
| System | B | Enc. | Dec. | (M) | (G/s) | (dB) |
| 1 | 8 | (4, 2) | (4, 2) | 3.4 | 7.21 | 19.42 |
| 2 | 16 | (2, 1) | (2, 1) | 3.4 | 4.99 | 18.35 |
| 3 | 28 | (0, 0) | (0, 0) | 3.5 | 3.47 | 14.81 |
| 4 | 0 | (6, 3) | (6, 3) | 3.6 | 9.52 | 15.46 |
| 5 | 8 | (8, 4) | (0, 0) | 3.4 | 7.21 | 18.21 |
| 6 | 8 | (0, 0) | (8, 4) | 3.4 | 7.21 | 16.78 |
| 7 | 8 | (6, 3) | (2, 1) | 3.4 | 7.21 | 18.75 |
| 8 | 8 | (2, 1) | (6, 3) | 3.4 | 7.21 | 19.37 |

In Table 1, System represents the LAGNet with different configurations depending on the combination of B and (C₁, C₂). The number of parameters indicates the size of the model, and Multiply and Accumulations (MACs) indicates the amount of computation required for the model. As shown in Table 1, by adjusting B and (C₁, C₂), different LAGNets may be constructed to have similar sizes or similar amounts of computation. In Table 1, speech separation performance is measured by SI-SNRi.

According to Table 1, configuration for the LAGNet with the optimal performance, optimal size, and optimal amount of computation may be inferred. Compared to the reference configuration, System 1, Systems 2 to 4 include varying numbers of global blocks, local blocks in the encoder stage, and local blocks in the decoder stage. The performance degradation observed in Systems 2 to 4 demonstrates the necessity of the constituting elements. Systems 5 to 8 include different numbers of local blocks in the encoder stage and local blocks in the decoder stage, while maintaining the same number of global blocks. Since System 8 shows better performance than System 7, it may be determined that the temporal reconstruction capability of the decoder is more important in the multi-scale sequence model.

Tables 2 and 3 show simulation results for the LAGNet and the latest speech separation models.

TABLE 2

| | | | WSJ0-2Mix | | WHAM! | |
|---|---|---|---|---|---|---|
| | Parameters | MACs | SI-SNRi | SDRi | SI-SNRi | SDRi |
| System (Years) | (M) | (G/s) | (dB) | (dB) | (dB) | (dB) |
| Conv-TasNet (2019) | 5.1 | 10.5 | 15.3 | 15.6 | 12.7 | — |
| DPRNN (2020) | 2.6 | 88.5 | 18.8 | 19.0 | 13.7 | 14.1 |
| SuDoRM-RF (2020) | 6.4 | 10.1 | 18.9 | — | 13.7 | 14.1 |
| Sepformer (2021) | 26.0 | 86.9 | 20.4 | 20.5 | 14.4 | 15.0 |
| LAGNet | 3.4 | 7.2 | 19.6 | 19.8 | 15.2 | 15.4 |
| LAGNet-large | 3.8 | 13.4 | 20.1 | 20.3 | 15.5 | 15.7 |

TABLE 3

| | Parameters | MACs | RTF-GPU | |
|---|---|---|---|---|
| System (Years) | (M) | (G/s) | (10⁻³) | RTF-GPU |
| Conv-TasNet (2019) | 5.1 | 10.2 | 14.1 | 0.43 |
| DPRNN (2020) | 2.6 | 85.5 | 59.9 | 3.52 |
| SuDoRM-RF (2020) | 6.4 | 10.0 | 43.3 | 1.05 |
| Sepformer (2021) | 26.7 | 115.5 | 37.1 | 4.17 |
| LAGNet | 3.4 | 7.2 | 16.7 | 0.49 |
| LAGNet-large | 3.8 | 13.4 | 20.6 | 1.02 |

In Tables 2 and 3, speech separation performance is evaluated using SI-SNRi and SDRi. Higher SI-SNRi and SDRi values indicate better speech separation performance. The Real Time Factor (RTF), which represents the model's computational speed, is calculated by dividing the model's processing time by the duration of the input. Duration and processing time in Tables 2 and 3 are measured in seconds.

As shown in Table 2, the LAGNet achieves performance comparable to those of the latest speech separation models (DPRNN, Sepformer) in terms of SI-SNRi, while using less than 10% of the computational resources in terms of MACs. Additionally, in noisy environments (WHAM!), the LAGNet may be trained and evaluated to perform noise removal and speech separation simultaneously.

As shown in Table 3, compared to the latest speech separation models (DPRNN, Sepformer), the LAGNet improves RTF by 72% and 55% in a Graphical Processing Unit (GPU) environment. Also, compared to the latest speech separation models (DPRNN, Sepformer), the LAGNet improves RTF by more than 86 to 90% in a Central Processing Unit (CPU) environment.

As shown in the simulation results of Tables 2 and 3, the LAGNet according to the present disclosure has similar separation performance compared to the latest speech separation models, while significantly improving performance in terms of model size reduction, computational resources required for the model, and the computational speed of the model.

In the simulations shown in Tables 2 and 3, the LAGNet-large is a model that enhances computational capability to improve performance.

The LAGNet according to the present disclosure may be used as a preprocessing module for a speech recognition apparatus using speech separation.

Tables 4 and 5 show the speech recognition performance of the LAGNet based on the speech separation preprocessing. Table 4 shows the speech recognition performance based on the speech separation preprocessing from speeches with echoes. Table 5 shows the speech recognition performance based on the speech separation preprocessing from noisy speeches.

TABLE 4
WER on LibriCSS

| | Overlap Ratio in % | | | | | |
|---|---|---|---|---|---|---|
| Condition | 0S | 0L | 10 | 20 | 30 | 40 |
| Input | 11.8 | 11.7 | 18.8 | 27.2 | 35.6 | 43.3 |
| DPRNN-fast | 10.6 | 10.4 | 12.7 | 16.6 | 20.8 | 23.5 |
| LAGNet-fast | 11.1 | 10.8 | 11.9 | 14.5 | 17.4 | 19.5 |
| LAGNet | 10.9 | 10.9 | 12.1 | 14.4 | 17.5 | 19.5 |

TABLE 5
WER on Car-simulated Dataset Based on LibriCSS (SNR = 10 dB)

| | | Overlap Ratio in % | | | | | |
|---|---|---|---|---|---|---|---|
| Condition | SIR(dB) | 0S | 0L | 10 | 20 | 30 | 40 |
| Input | 10 | 10.5 | 11 | 15.5 | 18.6 | 22.9 | 27.4 |
| DPRNN-fast | | 8.0 | 8.9 | 8.7 | 10.4 | 11.9 | 11.9 |
| LAGNet-fast | | 6.4 | 7.1 | 7.4 | 8.7 | 9.1 | 8.9 |
| LAGNet | | 6.3 | 7.3 | 7.1 | 7.9 | 8.7 | 8.7 |
| Input | 5 | 9.7 | 10.6 | 17.3 | 22.3 | 28 | 32.6 |
| DPRNN-fast | | 7.9 | 8.2 | 9.9 | 10.4 | 11.6 | 12.4 |
| LAGNet-fast | | 6.3 | 7.3 | 7.5 | 8.1 | 9.2 | 9.4 |
| LAGNet | | 6.5 | 6.6 | 7.2 | 8.0 | 8.4 | 8.6 |
| Input | 0 | 9.6 | 10.5 | 17.9 | 25.2 | 31.7 | 37.3 |
| DPRNN-fast | | 7.7 | 8.5 | 9.7 | 11.6 | 12.8 | 13.0 |
| LAGNet-fast | | 6.3 | 7.4 | 7.8 | 9.1 | 10.0 | 10.1 |
| LAGNet | | 6.4 | 7.3 | 7.4 | 8.2 | 8.7 | 8.8 |

In Tables 4 and 5, Word Error Rate (WER) is used as a performance metric representing the speech recognition rate. The overlap ratio is expressed as %. Both 0S and 0L have an overlap ratio of 0% but differ from each other based on whether the silent section is short or long. The LibriCSS database, used for continuous speech separation, allows overlap between utterances of different speakers.

As shown in Tables 4 and 5, the LAGNet achieves a higher recognition rate while using fewer computational resources compared to DPRNN. In other words, for non-overlapping and partially overlapping speeches, the LAGNet may serve as a robust preprocessing module for speech separation. Also, the LAGNet may help improve the speech recognition rate by effectively separating the speech sources in the presence of reflections or noise.

In the simulations shown in Tables 4 and 5, LAGNet-fast and DPRNN-fast correspond to the models requiring reduced computational resources to improve processing speed.

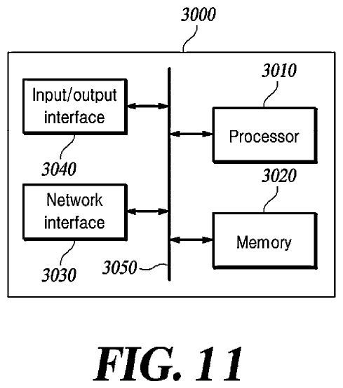

FIG. 11 is a block diagram illustrating an example of a computing device according to one embodiment of the present disclosure.

A method for separating speeches by a deep learning model according to embodiments of the present disclosure may be implemented by the computing device 3000 shown in FIG. 11.

As shown in FIG. 11, the computing device 3000 may include at least one processor 3010, a memory 3020, a network interface 3030, and an input/output interface 3040. A bus 3050 provides a mechanism to allow constituting elements of the computing device 3000 to communicate with each other as intended. Although the bus 3050 is schematically depicted as a single bus, multiple buses could be used in alternative implementations.

The processor 3010 may be configured to process instructions of a computer program by performing basic arithmetic, logic, and input/output operations. Instructions may be provided to the processor 3010 via the memory 300 or the network interface 3030. For example, the processor 3010 may be configured to execute instructions provided according to program codes stored in a recording device such as the memory 3020.

The memory 3020 is a computer-readable recording medium and may include a permanent mass storage device such as a random-access memory (RAM), a read-only memory (ROM), and a disk drive. Here, permanent mass recording devices such as the ROM and disk drives may be included in the computing device 3000 as an individual permanent storage device separated from the memory 3020.

Also, the memory 3020 may store an operating system and at least one program code. These software components are separate from the memory 3020 and may be loaded into the memory 3020 from a computer-readable recording medium. These separate recording media may include computer-readable recording media, such as floppy drives, disks, tapes, DVD/CD-ROM drives, and memory cards. In another embodiment, software components may be loaded into the memory 3020 through the network interface 3030 rather than a computer-readable recording medium. For example, software components may be loaded into the memory 3020 of the computing device 3000 based on a computer program installed by files received through the network interface 3030.

The network interface 3030 may provide functions for the computing device 3000 to communicate with other external devices (e.g., servers or terminals external to the computing device 3000) through a wired or wireless communication network. For example, requests, commands, data, or files generated by the processor 3010 of the computing device 3000 according to program codes stored in a recording device such as the memory 3020 may be transmitted to other external devices via a wired or wireless communication network according to the control of the network interface 3030. Conversely, signals, commands, data, or files from other external devices may be received by the computing device 3000 through the network interface 3030 of the computing device 3000 via a wired or wireless communication network. Signals, commands, or data received through the network interface 3030 may be transmitted to the processor 3010 or the memory 3020, while files may be stored in a storage medium that the computing device 3000 may further include (e.g., the separate recording medium described above).

The input/output interface 3040 may be a means for interfacing with an input/output device. For example, input devices may include devices such as a microphone, a keyboard, or a mouse, while output devices may include devices such as displays or speakers. In another example, the input/output interface 3040 may be a means for interfacing with a device that integrates input and output functions, such as a touch screen. The input/output device may be integrated into a single device along with the computing device 3000.

Also, according to other embodiments, the computing device 3000 may include fewer or more constituting elements than those in FIG. 11. For example, the computing device 3000 may be implemented to include at least part of the input/output devices or may further include other constituting elements such as a transceiver and a database.

Each component of the apparatus or method according to embodiments of the present disclosure may be implemented as hardware or software or implemented as a combination of hardware and software. Further, a function of each component may be implemented as software, and a microprocessor may also be implemented to execute the function of the software corresponding to each component.

Although the steps in the respective flowcharts are described to be sequentially performed, the steps merely instantiate the technical idea of some embodiments of the present disclosure. Therefore, a person having ordinary skill in the art to which the present disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure is not be limited by the above explicitly described embodiments but by the claims and equivalents thereof.

What is claimed is:

1. A speech separation apparatus comprising:
a local encoder including local encoder stages, wherein each local encoder stage is configured to generate local information by progressively compressing latent representations of mixed speech by using the local encoder stages and generating compressed output based on output of last local encoder stage;
a bottleneck including a global stage, the bottleneck configured to generate global information from the compressed output of the local encoder by using the global stage;
a local decoder including local decoder stages, wherein each local decoder stage is configured to generate reconstructed local information by progressively expanding the global information by using the local decoder stages and providing output of last local decoder stage as reconstructed latent output; and
a skip connection including global gates and local gates, the skip connection configured to
filter local information of the local encoder stages by using the global gates and the global information, and
filter output of the global gates by using the local gates and the reconstructed local information of the local decoder stages.

2. The speech separation apparatus of claim 1, wherein the local encoder additionally includes downsampling layers, wherein each downsampling layer is configured to downsample output of each of the local encoder stages and provide the downsampled output to next local encoder stage.

3. The speech separation apparatus of claim 1, wherein each global gate is configured to:
upsample the global information using an upsampling layer;
filter local information of each of the local encoder stages by using the upsampled global information to generate filtered output; and
provide the filtered output to the corresponding local gate.

4. The speech separation apparatus of claim 3, wherein each local gate is configured to:
upsample reconstructed local information of a previous local decoder stage of each of the local decoder stages by using an upsampling layer; and
generate a filtered sequence by filtering output of corresponding global gate by using the upsampled reconstructed local information.

5. The speech separation apparatus of claim 4, wherein each local gate is configured to:
generate output by adding the upsampled reconstructed local information and the filtered sequence; and
provide the generated output to each of the local decoder stages.

6. The speech separation apparatus of claim 5, wherein each global gate and the corresponding local gate connect each of the local encoder stages and corresponding local decoder stage.

7. The speech separation apparatus of claim 1, wherein:
each of the local encoder stages includes local blocks;
the local blocks are configured to generate the local information; and
each local block includes a convolutional local attention (CLA) module and a feed-forward network (FFN).

8. The speech separation apparatus of claim 7, wherein the CLA module includes a gated linear unit (GLU) and a 1-Dimensional Depthwise Convolution (D-Conv1D) block, and wherein the CLA module is configured to capture local context by dynamically gating input features based on the GLU.

9. The speech separation apparatus of claim 1, wherein:
the global stage includes global blocks;
the global blocks generate the global information; and
each global block includes a multi-head self attention (MHSA) module and a feed-forward network (FFN).

10. The speech separation apparatus of claim 1, wherein:
each of the local decoder stages includes local blocks;
the local blocks are configured to generate the reconstructed local information; and
each local block includes a convolutional local attention (CLA) module and a feed-forward network (FFN).

11. The speech separation apparatus of claim 1, further comprising:
an audio encoder configured to generate the latent representations from the mixed speech based on 1-D convolution, wherein the mixed speech is generated by mixing utterances from a plurality of speakers;
a linear layer configured to reshape reconstructed latent output of the local decoder to generate separated representations for each speaker; and
an audio decoder configured to reconstruct speech of each of the speakers based on the separated representations for each of the speakers and the latent representations based on 1-D convolution.

12. A method for separating speeches performed by a speech separation apparatus, the method comprising:
allowing each local encoder stage to generate local information by progressively compressing latent representations of mixed speech by using local encoder stages within a local encoder;
generating compressed output based on output of last local encoder stage;
generating global information from the compressed output of the local encoder by using a global stage;
allowing each local decoder stage to generate reconstructed local information by progressively expanding the global information by using local decoder stages within a local decoder;
providing output of last local decoder stage as reconstructed latent output;
filtering local information of the local encoder stages by using global gates and the global information; and
filtering output of the global gates by using local gates and reconstructed local information of the local decoder stages.

13. The method of claim 12, wherein generating the local information by each local encoder stage includes:
downsampling output of each local encoder stage by using a downsampling layer; and
providing the downsampled output to next local encoder stage.

14. The method of claim 12, wherein filtering the local information includes:
upsampling the global information by using an upsampling layer within each global gate;
generating filtered output by filtering local information of each local encoder stages by using the upsampled global information; and
providing the filtered output of each of the global gates to corresponding local gate.

15. The method of claim 14, wherein filtering the output of the global gates includes:
upsampling reconstructed local information of a previous local decoder stage of each of local decoder stage by using an upsampling layer within each local gate; and
generating a filtered sequence by filtering output of the corresponding global gate by using the upsampled reconstructed local information.

16. The method of claim 15, wherein filtering the output of the global gates includes:
generating output by adding the upsampled reconstructed local information and the filtered sequence; and
providing the generated output to each local decoder stage.

17. The method of claim 12, further comprising:
generating the latent representations from the mixed speech based on 1-D convolution, wherein the mixed speech is generated by mixing utterances from a plurality of speakers;
generating separated representations for each speaker by reshaping reconstructed latent output of the local decoder; and
reconstructing speech of each of the speakers based on the separated representations for each of the speakers and the latent representations based on 1-D convolution.

18. A non-transitory computer-readable recording medium storing instructions, wherein the instructions, when being executed by a processor, cause the processor to:
allow each local encoder stage to generate local information by progressively compressing latent representations of mixed speech by using local encoder stages within a local encoder;
generate compressed output based on output of last local encoder stage;
generate global information from the compressed output of the local encoder by using a global stage;
allow each local decoder stage to generate reconstructed local information by progressively expanding the global information by using local decoder stages within a local decoder;
provide output of last local decoder stage as reconstructed latent output;
filter local information of the local encoder stages by using global gates and the global information; and
filter output of the global gates by using local gates and reconstructed local information of the local decoder stages.
